(19) United States
(12) Patent Application Publication
(10) Pub. No.: US 2017/0263195 A1
(43) Pub. Date: Sep. 14, 2017

(54) DISPLAY APPARATUS

(71) Applicant: FUNAI ELECTRIC CO., LTD., OSAKA (JP)

(72) Inventors: HIROSHI ITOI, Osaka (JP); HIROHISA KITAGISHI, Nara (JP); HIROYUKI ISHIBASHI, Osaka (JP)

(73) Assignee: FUNAI ELECTRIC CO., LTD., OSAKA (JP)

(21) Appl. No.: 15/450,032

(22) Filed: Mar. 6, 2017

(30) Foreign Application Priority Data
Mar. 8, 2016 (JP) 2016-044373

(51) Int. Cl. G09G 3/34

(52) U.S. Cl. CPC G09G 3/3426; G09G 2320/0233; G09G 2320/0646; G09G 2320/0261; G09G 2330/023

(57) ABSTRACT

Provided is a display apparatus that the image display quality does not deteriorate even if the screen size is increased. The display apparatus includes a display; a plurality of light sources; and a controller controlling the light sources. When a character information is present in a display region of the display, the controller controls a luminance of at least a region comprising the character information to be higher than a predetermined luminance.

### CROSS-REFERENCE TO RELATED APPLICATION

This application claims the priority benefit of Japan application serial no. 2016-044373, filed on Mar. 8, 2016. The entirety of the above-mentioned patent application is hereby incorporated by reference herein and made a part of this specification.

### BACKGROUND OF THE INVENTION

Field of the Invention

The invention relates to a display apparatus for displaying images.

Description of Related Art

A conventional display apparatus is known, which includes a display that utilizes a liquid crystal panel, and a backlight that has a plurality of light sources for generating a light for irradiating the display. In order to improve the apparent brightness under the power consumption limit of the backlight, in practice, the luminance distribution of the backlight of the display apparatus may be controlled to make the central part of the screen of the display brighter than the peripheral part (refer to Patent Literature 1, Japanese Patent Publication No. 2002-55675).

In recent years, in order to suppress power consumption of the backlight which is enlarged in accordance with the increasing screen size of the display, it becomes more and more common to use LED (Light Emitting Diode) as the light source. For the large-sized display apparatus that includes a large number of LEDs, however, if the peripheral light amount ratio is designed to be small as the conventional device, a sense of incompatibility may occur when an image including character information is displayed on the entire screen or when different images are displayed in multiple divided regions of the screen.

### SUMMARY OF THE INVENTION

The invention provides a display apparatus that the image display quality does not deteriorate even if the screen size is increased.

In view of the above, one embodiment of the disclosure provides a display apparatus including a display; a plurality of light sources, generating a light that irradiates the display; and a controller controlling a luminance of the light sources. When a character information is present in a display region of the display, the controller controls a luminance of at least a region comprising the character information to be higher than a predetermined luminance.

According to the invention, presence of the character information is associated with the luminance control of the light sources considering that the character information draws the user's attention, so as to achieve the display apparatus that the image display quality does not deteriorate even if the screen size is increased.

### BRIEF DESCRIPTION OF THE DRAWINGS

FIG. 1 is a block diagram showing the basic configuration of the display apparatus according to the invention.

FIG. 2 is a front view showing the LED configuration of the backlight in the display apparatus according to the first embodiment.

FIG. 3 is a diagram showing two examples of the LED luminance control of the backlight of FIG. 2.

FIG. 4 is a front view showing an example of region division of the backlight in the display apparatus according to the second embodiment.

FIG. 5 is a diagram showing the relationship between the luminance difference between the central part and the peripheral part and the movement amount of the image in each region of the backlight of FIG. 4.

FIG. 6A, FIG. 6B, FIG. 6C, and FIG. 6D are diagrams respectively showing specific examples of the relationship of FIG. 5.

FIG. 7 is a diagram showing an example of the luminance control of each LED in the backlight of FIG. 4.

FIG. 8 is a diagram showing a comparison between the average LED currents of the regions in the example of FIG. 7.

FIG. 9 is a diagram showing another example of the luminance control of each LED in the backlight of FIG. 4.

FIG. 10 is a diagram showing a comparison between the average LED currents of the regions in the example of FIG. 9.

FIG. 11 is a diagram showing yet another example of the luminance control of each LED in the backlight of FIG. 4.

FIG. 12 is a diagram showing a comparison between the average LED currents of the regions in the example of FIG. 11.

FIG. 13 is a front view showing an example of region division of the display in the display apparatus according to the third embodiment.

FIG. 14 is a diagram showing a comparison between the average LED currents of the regions in the example of FIG. 13.

FIG. 15 is a front view of the first modified example of FIG. 13.

FIG. 16 is a front view of the second modified example of FIG. 13.

FIG. 17 is a front view of the display in the display apparatus according to the fourth embodiment.

FIG. 18 is a plan view showing the positional relationship between the display of FIG. 17 and the user.

FIG. 19 is a diagram showing the maximum size of the image display region, which the person at the recommended viewing distance can watch in an instant, with respect to the display in various sizes.

FIG. 20 is a front view showing an example of the screen when the image display region is smaller than the predetermined size.

FIG. 21 is a front view showing an example of the screen when the image display region is larger than the predetermined size and character information is not present in the outer edge part of the image display region.

FIG. 22 is a front view showing an example of the screen when the image display region is larger than the predetermined size and character information is present in the outer edge part of the image display region.

FIG. 23 is a front view showing an example of the image display region on the display of the display apparatus according to the fifth embodiment.

FIG. 24 is a front view of a modified example of the example of FIG. 23.

### DESCRIPTION OF THE EMBODIMENTS

Hereinafter, embodiments of the invention are described in detail with reference to the figures.

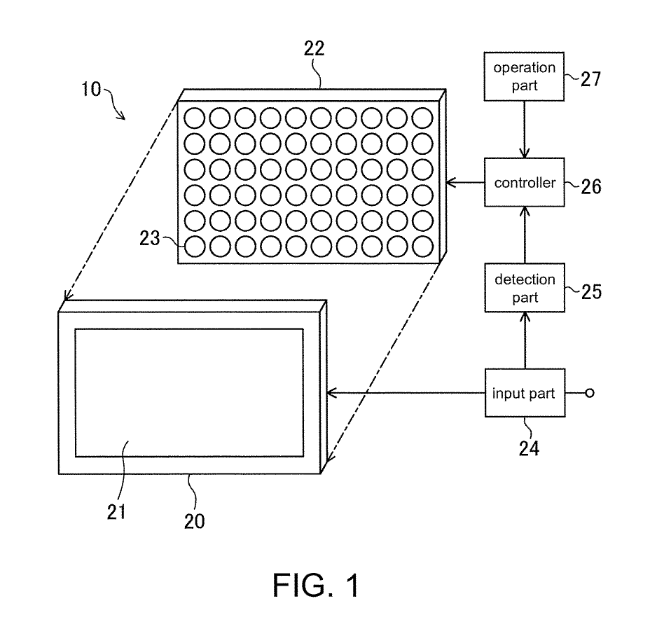

FIG. 1 is a block diagram showing a basic configuration of a display apparatus according to the invention. A display apparatus 10 of FIG. 1 includes a liquid crystal panel 20 that serves as a display having a screen 21, and a backlight 22 that serves as a light source part. The backlight 22 includes a plurality of LEDs 23 that constitute a plurality of light sources for generating a light for irradiating the liquid crystal panel 20.

The display apparatus 10 further includes an input part 24, a detection part 25, a controller 26, and an operation part 27. The input part 24 sends a given image signal to the liquid crystal panel 20 and the detection part 25. The detection part 25 detects a movement amount of an image in a predetermined region on the screen 21 of the display 20. Alternatively, the detection part 25 detects character information in the predetermined region on the screen 21 of the display 20. The character information mentioned here, for example, includes character image data that is embedded in other images in a broadcast wave, and also includes text data that is transmitted together with image data, audio data, and so on in the broadcast wave and includes information composed of symbols, numbers, and words, etc. The controller 26 controls luminances of the LEDs located in an image display region, among the multiple LEDs 23, based on a detection result of the detection part 25. In particular, when the character information is present in the image display region of the display 20, the controller 26 controls the luminances of the LEDs, so as to at least brighten the region including the character information. The operation part 27 transmits various instructions from a user to the controller 26.

The detection part 25 is capable of executing determination of the movement amount, determination of a still image/a moving image, and determination of an image including a natural image/character information by various methods, such as frame difference detection, image edge detection, chromaticity change detection, etc. Here, the natural image refers to a still image of natural scenery which reflects the sky, sea, and sand beach, for example.

For example, a still image and a moving image can be distinguished from each other by a difference between data values of the same pixel in the screen of a previous frame. Specifically, a difference in signal level of the same pixel between multiple frames is extracted. If a sum of the difference values exceeds a certain level, the image is determined as a moving image. It utilizes that the values of the same pixel in the still image have a high correlation and thus the sum is small, but for the moving image, the correlation between the values of the same pixel is considerably lower than that of the still image.

Even in the same still image, a natural image and an image including character information can still be distinguished from each other by a difference between the data values of adjacent pixels in one screen. Specifically, a difference in signal level between the adjacent pixels is extracted. If a sum of the difference values in one screen exceeds a certain level, the image is determined as an image that includes character information. It utilizes that the values of the adjacent pixels in the natural image have a high correlation and thus the sum is small, but for the image including character information, the correlation between the values of the adjacent pixels is considerably lower than that of the natural image.

Hereinafter, the display apparatus 10 is described according to five embodiments, but they all have the basic configuration of FIG. 1.

### First Embodiment

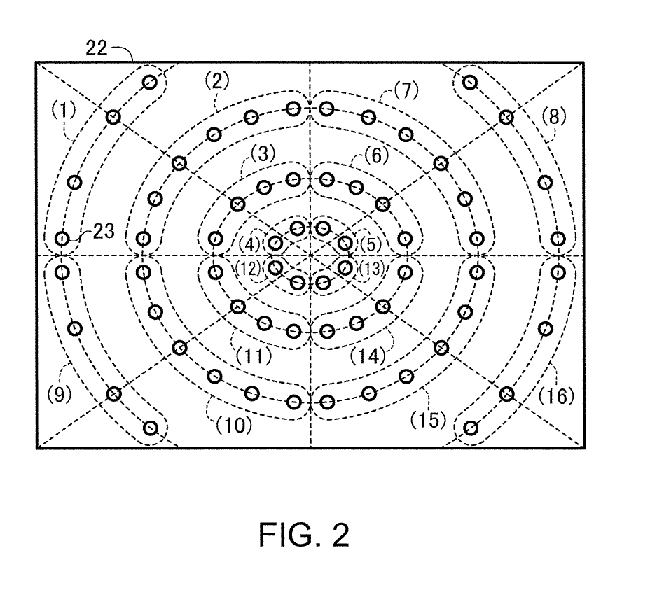

FIG. 2 is a front view showing the LED configuration of the backlight 22 in the display apparatus 10 according to the first embodiment. The multiple LEDs 23, i.e., the respective light sources, are positioned to draw a plurality of concentric ellipses, and are arranged more densely when they are closer to the center. Then, these LEDs 23 are divided into first to sixteenth LED groups (1) to (16), as shown in FIG. 2. The first, the second, the third, and the fourth LED groups (1), (2), (3), and (4) are arranged in this order from a peripheral part to a central part in an upper left portion of the backlight 22. The fifth, the sixth, the seventh, and the eighth LED groups (5), (6), (7), and (8) are arranged in this order from the central part to the peripheral part in an upper right portion of the backlight 22. The ninth, the tenth, the eleventh, and the twelfth LED groups (9), (10), (11), and (12) are arranged in this order from the peripheral part to the central part in a lower left portion of the backlight 22. The thirteenth, the fourteenth, the fifteenth, and the sixteenth LED groups (13), (14), (15), and (16) are arranged in this order from the central part to the peripheral part in a lower right portion of the backlight 22.

If a type of an image is determined by the detection part 25 is a still image (the movement amount is substantially 0) and includes character information, the controller 26 controls the luminances of the first to the sixteenth LED groups (1) to (16) to be substantially equal, such that the entire screen 21 has substantially equal luminance. In this case, a luminance difference between the light sources of the central part and the peripheral part of the screen 21 is substantially 0. Moreover, if the type of the image is determined as a moving image (the movement amount is not 0) by the detection part 25, the controller 26 controls the luminances of the first to the sixteenth LED groups (1) to (16) to make the central part brighter than the peripheral part of the screen 21 and set the luminance difference thereof to a first predetermined value. Furthermore, if the type of the image is determined as a still image (the movement amount is substantially 0) by the detection part 25 and the image is a natural image, the controller 26 controls the luminances of the first to the sixteenth LED groups (1) to (16) to make the central part brighter than the peripheral part of the screen 21 and set the luminance difference thereof to a second predetermined value, which is smaller than the first predetermined value.

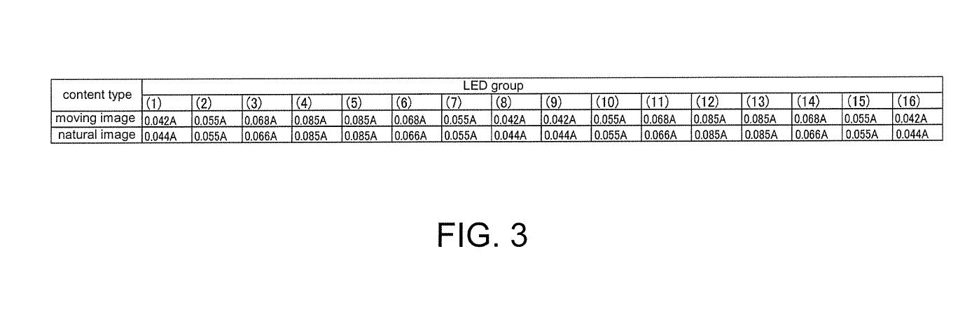

FIG. 3 shows two examples of the LED luminance control of the backlight 22 of FIG. 2 in the case of the moving image and the case of the natural image. A in FIG. 3 is a total luminance setting value of the backlight 22. It shows that, in the case of the moving image, for example, a luminance corresponding to 4.2% of the setting value A is allocated to the first LED group (1), and a luminance corresponding to 8.5% of the setting value A is allocated to the fourth LED group (4) respectively.

According to the example in the upper part of FIG. 3, if the type is determined as the moving image by the detection part 25, the controller 26 performs control to increase the luminances of the fourth, the fifth, the twelfth, and the thirteenth LED groups (4), (5), (12), and (13) located in the central part and decrease the luminances of the first, the eighth, the ninth, and the sixteenth LED groups (1), (8), (9), and (16) located in the peripheral part. The luminance difference thereof is 0.043A.

According to the example in the lower part of FIG. 3, if the type determined by the detection part 25 is a still image and a natural image, the controller 26 performs control to increase the luminances of the fourth, the fifth, the twelfth, and the thirteenth LED groups (4), (5), (12), and (13) located in the central part and decrease the luminances of the first, the eighth, the ninth, and the sixteenth LED groups (1), (8), (9), and (16) located in the peripheral part. The luminance difference thereof is 0.041A.

According to this embodiment, the multiple LEDs 23 are arranged on the concentric ellipses in the backlight 22 and the luminances of the multiple LEDs 23 are group-controlled according to the movement amount of the image displayed on the screen 21. Thus, even if the size of the screen is increased, the image display quality of the display apparatus 10 does not deteriorate. Moreover, in comparison with a case where the luminance of each LED 23 is controlled individually, the configuration of the controller 26 is simplified.

### Second Embodiment

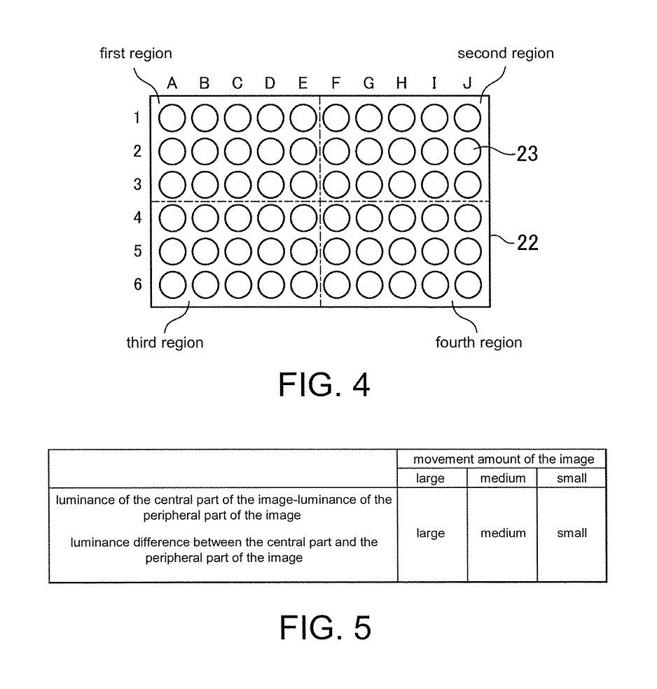

FIG. 4 is a front view showing an example of region division of the backlight 22 in the display apparatus 10 according to the second embodiment. Here, for simplicity of the explanation, sixty LEDs 23 are arranged in six rows and ten columns. In addition, the screen 21 of the liquid crystal panel 20 is divided into four regions, and corresponding thereto, the configuration region of the LEDs 23 is divided into first, second, third, and fourth regions. In the backlight 22, the first region includes the LEDs 23 from the first row to the third row and from the A column to the E column, the second region includes the LEDs 23 from the first row to the third row and from the F column to the J column, the third region includes the LEDs 23 from the fourth row to the sixth row and from the A column to the E column, and the fourth region includes the LEDs 23 from the fourth row to the sixth row and from the F column to the J column. Nevertheless, all or part of the sixty LEDs 23 in FIG. 4 may be an aggregate of multiple light sources.

The detection part 25 detects the movement amount of the image displayed in each of the four regions on the screen 21 of the liquid crystal panel 20. The controller 26 controls the luminances of the LEDs 23 according to the movement amount of the image detected by the detection part 25 for each region on the screen 21. Specifically, if the type of the image detected based on the region is a still image (the movement amount is substantially 0) and the image includes character information, the controller 26 controls the luminances of the LEDs 23 to make the entire region substantially equal in luminance. In this case, a luminance difference between the light sources of the central part and the peripheral part of the region is substantially 0. Moreover, if the type detected based on the region is a moving image (the movement amount is not 0), the controller 26 controls the luminances of the LEDs 23 to make the central part brighter than the peripheral part of the region. Furthermore, the controller 26 controls the luminances of the LEDs 23, such that the luminance difference between the light sources of the central part and the peripheral part increases as the movement amount of the image in the region increases.

In addition, the controller 26 is capable of selecting one of a first mode and a second mode for allocation of power consumption of each region. In the first mode, the controller 26 controls the luminances of the LEDs 23 to make an average luminance of each region substantially equal regardless of the movement amount of the image detected in each region. In the second mode, the controller 26 controls the luminances of the LEDs 23 such that an average luminance of a moving image region where the detected movement amount is not 0 is greater than an average luminance of a still image region where the detected movement amount is substantially 0, for example. In either of the first and the second modes, the controller 26 is capable of controlling the luminances of the LEDs 23, so as to increase or decrease the average luminance of at least one region instructed by the user by a remote control operation, etc., via the operation part 27.

FIG. 5 is a diagram showing the relationship between the luminance difference, which is between the central part and the peripheral part, and the movement amount of the image in each region of the backlight 22 of FIG. 4. The controller 26 controls the luminances of the LEDs 23, such that the luminance difference between the light sources of the central part and the peripheral part of each region increases as the movement amount of the image of the region increases. The reason is that the faster the image moves, the more the user's point of view focuses in the central part.

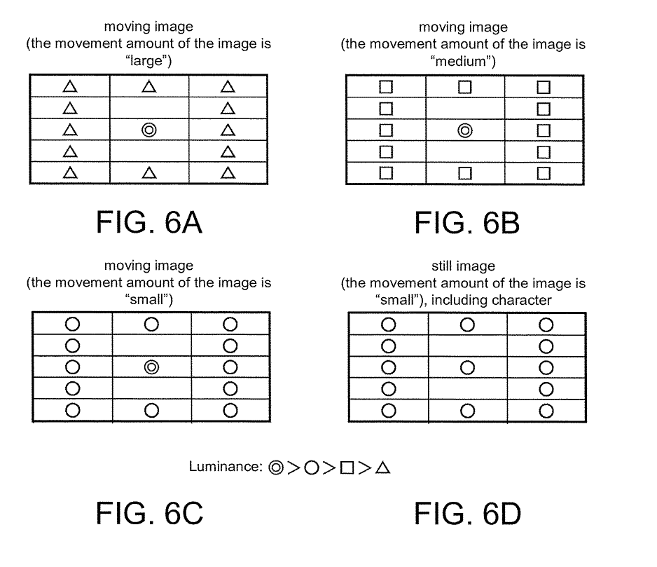

FIG. 6A, FIG. 6B, FIG. 6C, and FIG. 6D respectively show specific examples of the relationship of FIG. 5. According to FIG. 6A, when the movement amount of the moving image in the region is “large,” the luminance difference between the light sources of the central part and the peripheral part of the region is increased. According to FIG. 6B, when the movement amount of the moving image in the region is “medium,” the luminance difference between the light sources of the central part and the peripheral part of the region is moderate. According to FIG. 6C, when the movement amount of the moving image in the region is “small,” the luminance difference between the light sources of the central part and the peripheral part of the region is decreased. Further, according to FIG. 6D, when the image in the region is a still image (the movement amount is substantially 0) and the image includes character information, the luminance difference between the light sources of the central part and the peripheral part of the region is set to substantially 0.

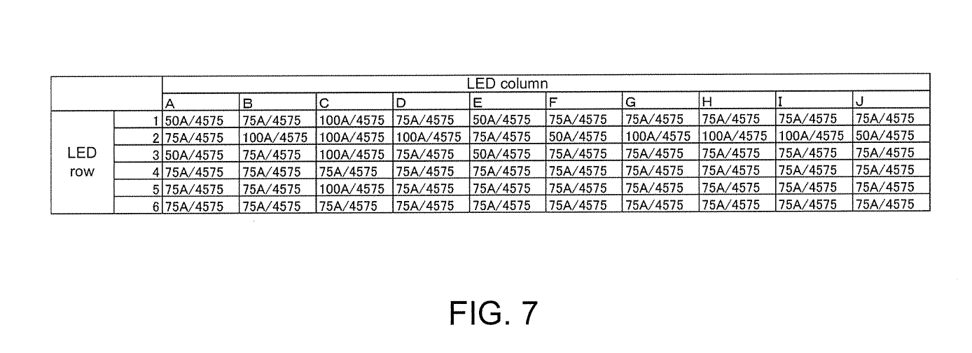

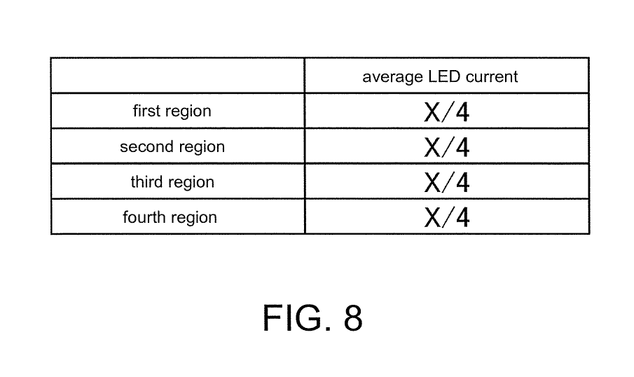

FIG. 7 is a diagram showing an example of the first mode luminance control of the LEDs 23 in the backlight 22 of FIG. 4. FIG. 8 is a diagram showing a comparison between the average LED currents of the regions in the example of FIG. 7. Here, moving images are respectively displayed in the first, the second and the third regions while a still image including character information is displayed in the fourth region.

According to the numerical example of FIG. 7, when the total luminance setting value of the backlight 22 is A, for example, the luminance of the LED 23 located in the first row and the A column is controlled to be a value obtained by dividing 50A by 4575.

Furthermore, according to FIG. 7, in the first region that includes the LEDs 23 from the first row to the third row and from the A column to the E column, the luminances of the LEDs 23 are controlled to make the central part brighter than the peripheral part of the first region, so as to be suitable for displaying a moving image with a large movement amount (a maximum luminance difference between the central part and the peripheral part=50A/4575). The second region that includes the LEDs 23 from the first row to the third row and from the F column to the J column is substantially the same as the first region. On the other hand, in the third region that includes the LEDs 23 from the fourth row to the sixth row and from the A column to the E column, the luminances of the LEDs 23 are controlled to make the central part brighter than the peripheral part of the third region, so as to be suitable for displaying a moving image with a small movement amount (the maximum luminance difference between the central part and the peripheral part=25A/4575). Moreover, in the fourth region that includes the LEDs 23 from the fourth row to the sixth row and from the F column to the J column, the luminances of the LEDs 23 are controlled to make the entire region substantially uniform in luminance, so as to be suitable for displaying a still image that includes character information (the luminance difference between the central part and the peripheral part=0).

When the average luminance of each region is calculated based on the numerical example of FIG. 7, the average luminance of every region is 1143.75A/4575=A/4. Corresponding thereto, according to FIG. 8, the average LED current is controlled to be X/4 for every region. Here, X is a total LED current setting value of the backlight 22.

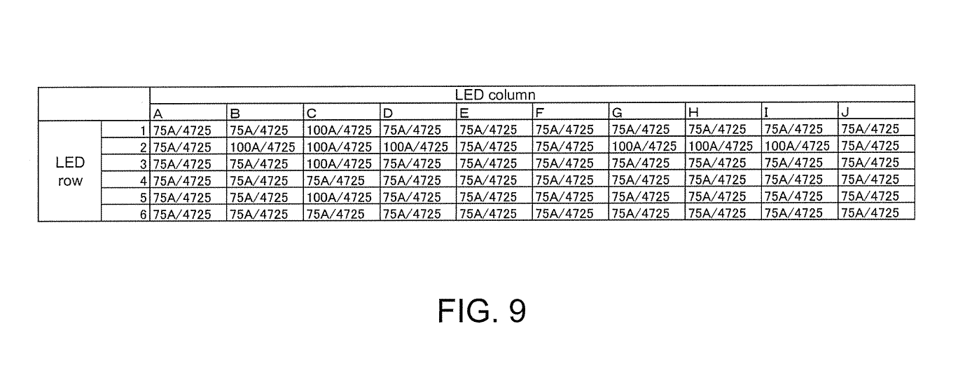

FIG. 9 is a diagram showing an example of the second mode luminance control of the LEDs 23 in the backlight 22 of FIG. 4. FIG. 10 is a diagram showing a comparison between the average LED currents of the regions in the example of FIG. 9. Here, moving images are respectively displayed in the first, the second and the third regions while a still image including character information is displayed in the fourth region.

According to FIG. 9, in the first region that includes the LEDs 23 from the first row to the third row and from the A column to the E column, the luminances of the LEDs 23 are controlled to make the central part brighter than the peripheral part of the first region, so as to be suitable for displaying a moving image (the maximum luminance difference between the central part and the peripheral part=25A/4725). The second region that includes the LEDs 23 from the first row to the third row and from the F column to the J column is the same as the first region. Moreover, the third region that includes the LEDs 23 from the fourth row to the sixth row and from the A column to the E column is the same as the first region as well. On the other hand, in the fourth region that includes the LEDs 23 from the fourth row to the sixth row and from the F column to the J column, the luminances of the LEDs 23 are controlled to make the entire region substantially uniform in luminance, so as to be suitable for displaying a still image that includes character information (the luminance difference between the central part and the peripheral part=0).

When the average luminance of each region is calculated based on the numerical example of FIG. 9, the average luminance of the first region is A/4+a, the average luminance of the second region is A/4+b, the average luminance of the third region is A/4−b, and the average luminance of the fourth region is A/4−a. However, A/4=1181.25A/4725, a=62.5A/4725, and b=25A/4725. Corresponding thereto, according to FIG. 10, the average LED current is controlled to be X/4+α in the first region, X/4+β in the second region, X/4−β in the third region, and X/4−α in the fourth region, respectively. Here, X is the total LED current setting value of the backlight 22, and α>β.

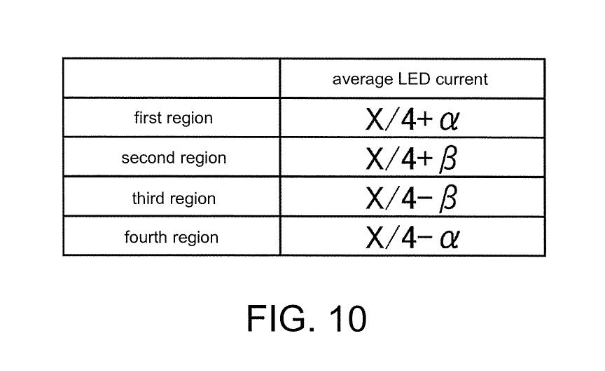

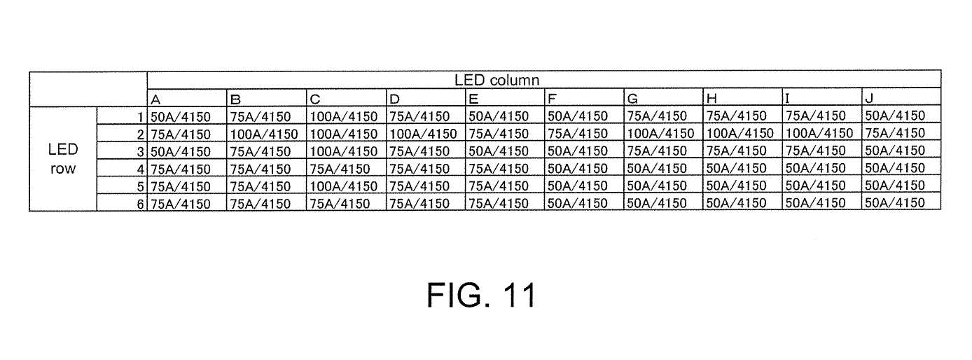

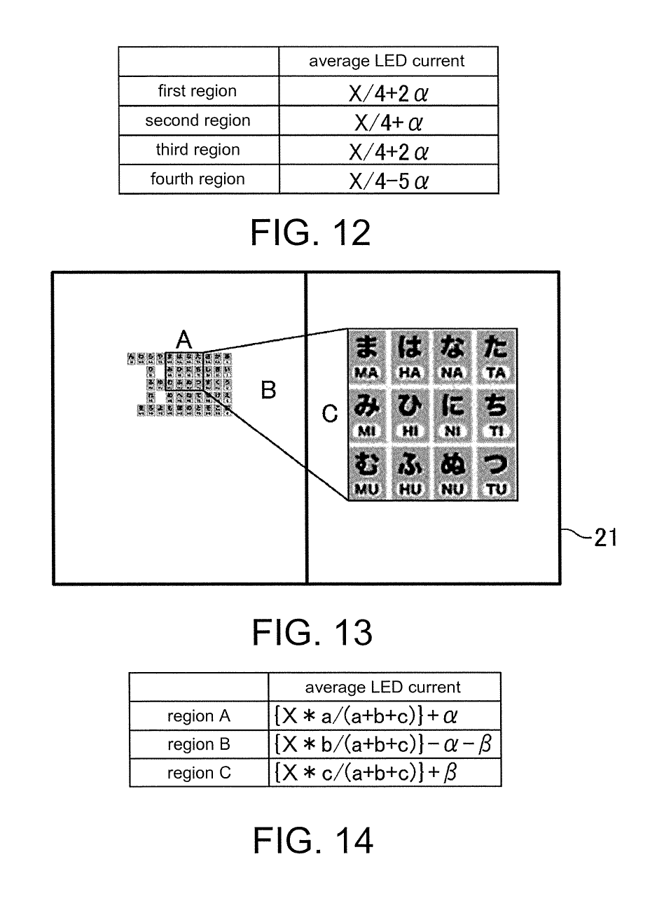

FIG. 11 is a diagram showing another example of the second mode luminance control of the LEDs 23 in the backlight 22 of FIG. 4. FIG. 12 is a diagram showing a comparison between the average LED currents of the regions in the example of FIG. 11. Here, moving images are respectively displayed in the first, the second, and the third regions while a still image including character information is displayed in the fourth region. However, it is specified by the user via the operation part 27, so as to increase the average luminance of the third region in comparison with the cases of FIG. 9 and FIG. 10.

According to FIG. 11, in the first region that includes the LEDs 23 from the first row to the third row and from the A column to the E column, the luminances of the LEDs 23 are controlled to make the central part brighter than the peripheral part of the first region, so as to be suitable for displaying a moving image with a large movement amount (the maximum luminance difference between the central part and the peripheral part=50A/4150). The second region that includes the LEDs 23 from the first row to the third row and from the F column to the J column is the same as the first region. On the other hand, in the third region that includes the LEDs 23 from the fourth row to the sixth row and from the A column to the E column, the luminances of the LEDs 23 are controlled to make the central part brighter than the peripheral part of the third region, so as to be suitable for displaying a moving image with a small movement amount (the maximum luminance difference between the central part and the peripheral part=25A/4150). Moreover, in the fourth region that includes the LEDs 23 from the fourth row to the sixth row and from the F column to the J column, the luminances of the LEDs 23 are controlled to make the entire region substantially uniform in luminance, so as to be suitable for displaying a still image that includes character information (the luminance difference between the central part and the peripheral part=0).

When the average luminance of each region is calculated based on the numerical example of FIG. 11, the average luminance of the first region is A/4+2a, the average luminance of the second region is A/4+a, the average luminance of the third region is A/4+2a, and the average luminance of the fourth region is A/4−5a. However, A/4=1037.5A/4150, and a=62.5A/4150. Corresponding thereto, according to FIG. 12, the average LED current is controlled to be X/4+2a in the first region, X/4+a in the second region, X/4+2a in the third region, and X/4−5a in the fourth region, respectively.

Here, X is the total LED current setting value of the backlight 22. It is known that, in FIG. 10, the average LED current of the third region is controlled to be lower than X/4, but in FIG. 12, the average LED current of the third region is controlled to be higher than X/4 in response to what the user specifies.

The controller 26 is capable of performing control to maintain the total luminance setting value A in the examples of FIG. 7, FIG. 9, and FIG. 11 a constant value. In this case, if the average luminance of a certain region is increased, the average luminances of the other regions are reduced, so as to keep the total luminance of the entire backlight 22 a constant value. The total LED current setting value X in the examples of FIG. 8, FIG. 10, and FIG. 12 is also controlled to be a constant value. If the total LED current of a certain region is increased, the average LED currents of the other regions are reduced, so as to keep the total LED current, that is, the power consumption, of the entire backlight 22 a constant value.

According to this embodiment, in a screen displayed with multiple regions, it is possible to achieve the optimum luminance setting of the light source part according to the movement amount of the respective region. Therefore, the display quality of each image can be improved within limited power consumption.

The screen is not necessarily divided into four. The LED elliptical configuration as described in the first embodiment may also be used in each divided region.

### Third Embodiment

FIG. 13 is a front view showing an example of screen region division of the liquid crystal panel 20 in the display apparatus 10 according to the third embodiment. According to FIG. 13, the screen 21 of the liquid crystal panel 20 is divided into two on the left and the right. An image on the left screen is a master image (first image) and an image on the right screen is a slave image (second image). Then, a region A in the master image is specified via the operation part 27. An image of the region A, i.e., the specified region in the master image, is enlargedly displayed in a region C, that is, the slave image. A region B in FIG. 13 represents a region other than the region A in the master image.

FIG. 14 is a diagram showing a comparison between the average LED currents of the regions in the example of FIG. 13. According to FIG. 14, if a display area of the region A is a, a display area of the region B is b, and a display area of the region C is c, the average LED current is controlled to be {X*a/(a+b+c)}+α in the region A, {X*b/(a+b+c)}−α−β in the region B, and {X*c/(a+b+c)}+β in the region C, respectively. Here, X is the total LED current setting value of the backlight 22. α and β are set such that (current per unit display area of the region A)<(current per unit display area of the region C).

According to FIG. 14, the luminance of the backlight 22 is controlled to make the enlarged image of the region C brighter than the image of the region A. Thus, the user's point of view is directed to the enlarged image of the region C rather than the image of the region A. As a result, the image of interest can be shown clearly in a close-up manner. In addition, because the luminance of the backlight 22 is controlled to make the image of the region A brighter than the image of the region B, it is easy to know which part of the master image is the enlargedly displayed region. The luminance of the backlight 22 may also be controlled such that the image of the region A and the image of the region B have substantially the same luminance.

Here, the type of the image that is partially enlargedly displayed may be a still image or a moving image. When it is determined that the enlarged image of the region C is a still image (the movement amount is substantially 0) including character information as shown in FIG. 13, the entire region C is controlled to be substantially uniform in luminance. In this case, the luminance difference between the light sources of the central part and the peripheral part of the region C is substantially 0. Furthermore, when it is determined that the enlarged image of the region C is a moving image (the movement amount is not 0), the central part is controlled to be brighter than the peripheral part of the region C. In addition, control may be performed to increase the luminance difference between the light sources of the central part and the peripheral part as the movement amount of the image of the region C increases. In this way, luminance uniformity control or partially high luminance control of the backlight 22 is performed according to the movement amount of the image.

Regarding the region A in FIG. 13, the position thereof in the master image is preferably changeable by the user's remote control operation, etc., via the operation part 27.

As shown in FIG. 15, on the screen 21 of the liquid crystal panel 20, the enlarged display of the region C may be changed in conjunction with a width expansion of the region A. In this case, at least one of the position, shape, and size of the region A in the master image is changeable by the user's remote control operation, etc., via the operation part 27.

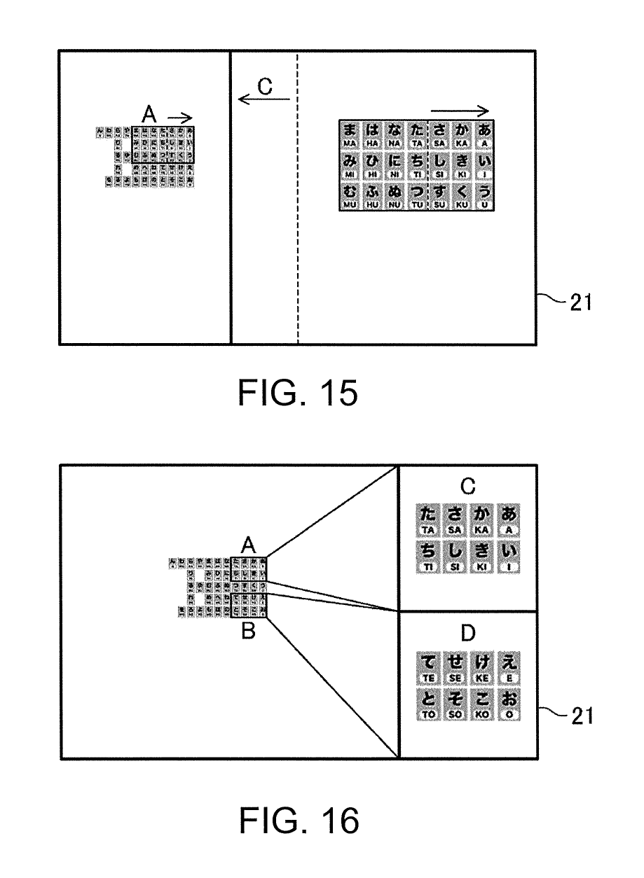

As shown in FIG. 16, the screen 21 of the liquid crystal panel 20 may be divided into three or more, one of which may be a master image (first image) and the others may be slave images (second images). In the example of FIG. 16, an image of a region A, i.e., the specified region in the master image, is enlargedly displayed in a region C, i.e., one slave image, and an image of a region B, i.e., the other specified region in the master image, is enlargedly displayed in a region D, i.e., the other slave image.

In this case, the LED luminance of the backlight 22 is also controlled to make the enlarged images of the region C and the region D brighter than the images of the region A and the region Bin the master image.

According to this embodiment, it is possible to achieve the optimum luminance setting of the light source part according to the movement amount of the image in each multi-displaying screen. Therefore, the display quality of the image can be improved. Moreover, presenting a particular region to the user by enlargedly displaying it also brings the effect of convenience.

### Fourth Embodiment

In the fourth embodiment, the detection part 25 has a function of detecting a size of an image display region where an image of one content on the screen 21 of the liquid crystal panel 20 is displayed, and a function of detecting character information in an outer edge part in the image display region. The controller 26 controls the luminances of the LEDs located in the image display region, among the multiple LEDs 23 that constitute the backlight 22, based on the detection result of the detection part 25.

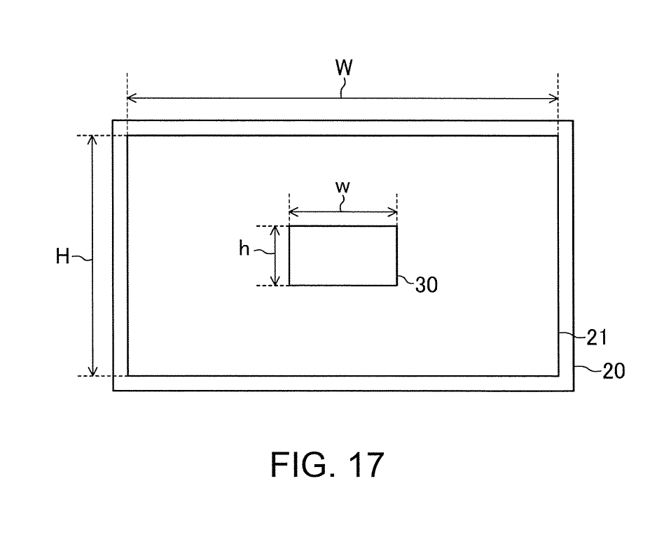

FIG. 17 is a front view of the liquid crystal panel 20 in the display apparatus 10 according to the fourth embodiment. Here, a width of the screen 21 is W and a height of the screen 21 is H, and W:H=16:9. The image display region 30 shown on the screen 21 is a region where the image of one content is displayed. A width of the image display region 30 is w and a height of the image display region 30 is h.

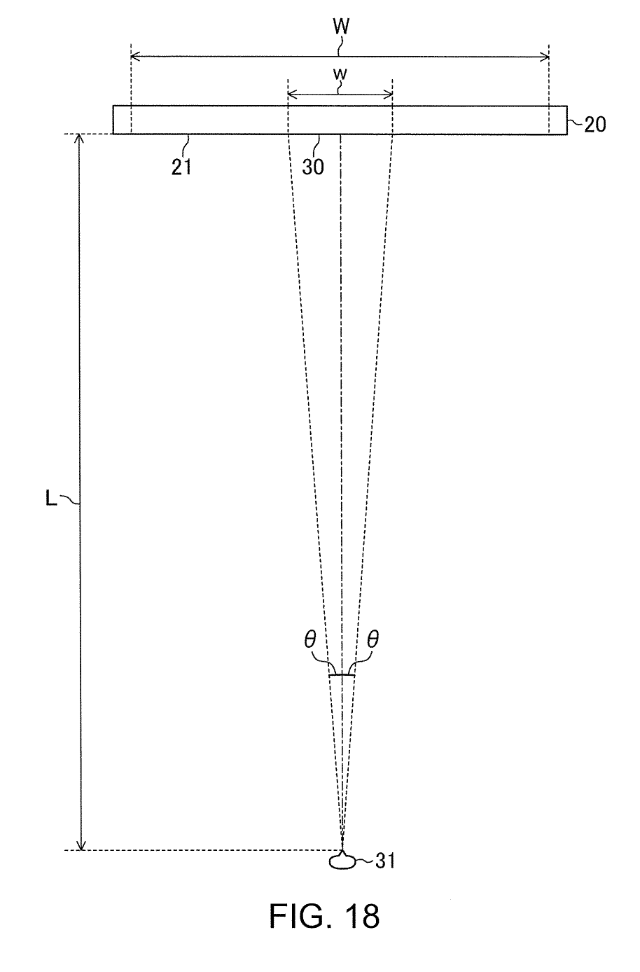

FIG. 18 is a plan view showing the positional relationship between the liquid crystal panel 20 of FIG. 17 and a user 31. The user 31 is away from the screen 21 of the liquid crystal panel 20 at a recommended viewing distance L. Here, if W:H=16:9, it is set that L=3*H. Then, if an angle that the image display region 30 having the width w is viewed by the user 31 is set to 2*0,

tan θ=(w/2)*(1/L) (1)

is satisfied.

In general, a maximum width w₀ of the image display region 30, which a person away from the screen 21 at the recommended viewing distance L can watch in an instant, is the value of the width w that is obtained from the equation (1) when θ=4.23°, and is equivalent to about ¼ of the width W of the screen 21. Likewise, a maximum height h₀ of the image display region 30, which the person can watch in an instant, is equivalent to about ¼ of the height H of the screen 21.

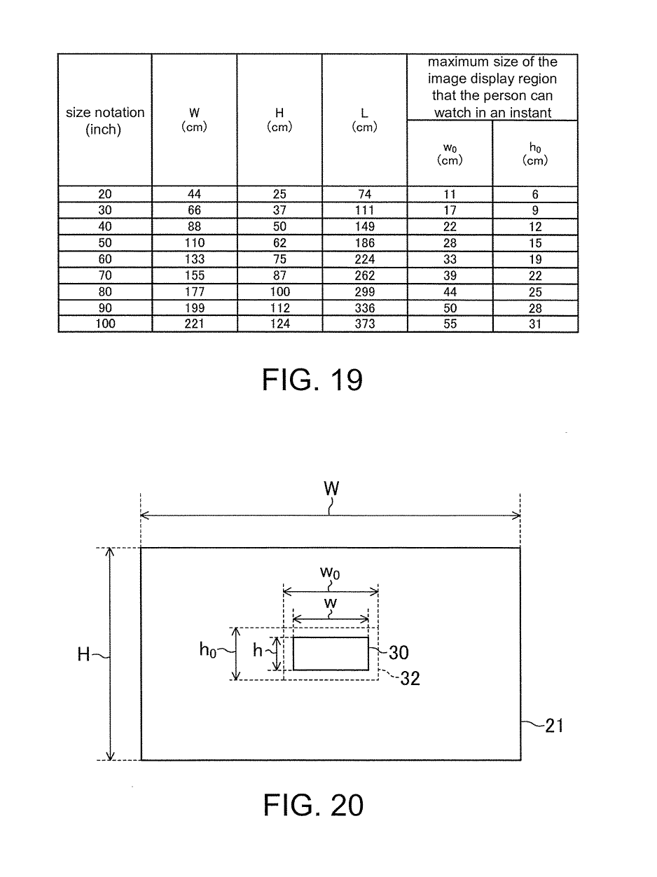

FIG. 19 is a diagram showing the maximum width w₀ and the maximum height h₀ of the image display region 30, which the person away from the screen 21 at the recommended viewing distance L can watch in an instant, with respect to the liquid crystal panel 20 in various sizes. With respect to the screen 21 with a size notation of 50 inches, for example, W=110 cm, H=62 cm, L=186 cm, w₀=28 cm, and h₀=15 cm, and it is understood that w₀=W/4 and h₀=H/4 are substantially satisfied.

FIG. 20 is a front view showing an example of the screen 21 when the image display region 30 is smaller than a size of a determination region 32 defined by the maximum width w₀ and the maximum height h₀. In this case, the user 31 is able to see the entire image display region 30 in an instant. In order to prevent the user from noticing the difference in luminance difference, it is preferable to make the entire image display region 30 substantially equal in luminance. Therefore, the controller 26 performs control to make the luminances of all the LEDs 23 located in the image display region 30 substantially equal regardless of whether character information is present or distinction between a still image and a moving image.

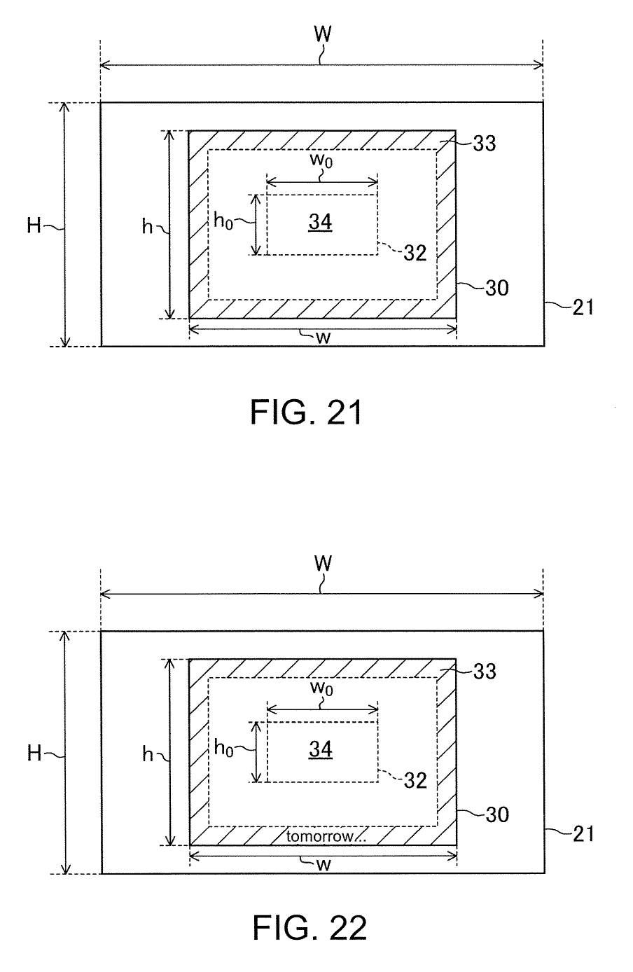

FIG. 21 is a front view showing an example of the screen 21 when the image display region 30 is larger than the size of the determination region 32 defined by the maximum width w₀ and the maximum height h₀ and character information is not present in an outer edge part 33 of the image display region 30. In this case, it is preferable to make the central part 34 brighter than the outer edge part 33, that is, reduce a peripheral light amount ratio, so as to improve the apparent luminance as well as suppress the power consumption of the backlight 22. Therefore, if the detection part 25 does not detect character information in the outer edge part 33, the controller 26 controls the luminances of the LEDs 23 located in the outer edge part 33 to be lower than the luminances of the LEDs 23 located in the image display region 30 other than the outer edge part 33.

FIG. 22 is a front view showing an example of the screen when the image display region 30 is larger than the size of the determination region 32 defined by the maximum width w₀ and the maximum height h₀ and character information is present in the outer edge part 33 of the image display region 30. Due to presence of the characters, the eyes of the user 31 are attracted to the characters of the outer edge part 33. In this case, if the peripheral light amount ratio is reduced as in the case of FIG. 21, the luminance difference between the outer edge part 33 and the central part 34 would result in a sense of incompatibility. Therefore, if the detection part 25 detects character information in the outer edge part 33, the controller 26 performs control to make the luminances of the LEDs 23 located in the entire outer edge part 33 substantially equal to the luminances of the LEDs 23 located in the image display region 30 other than the outer edge part 33. That is, the controller 26 performs control to make the luminances of all the LEDs 23 located in the image display region 30 substantially equal.

According to this embodiment, it is possible to achieve the optimum luminance setting of the light source part according to the size of the image display region 30 and whether the character information is present in the outer edge part 33. Therefore, the display quality of the image can be improved within limited power consumption.

### Fifth Embodiment

In the fifth embodiment, the detection part 25 has a function of detecting character information in a predetermined region within the outer edge part of the image display region on the screen 21 of the liquid crystal panel 20. The controller 26 controls the luminances of the LEDs located in the image display region, among the multiple LEDs 23 that constitute the backlight 22, based on the detection result of the detection part 25.

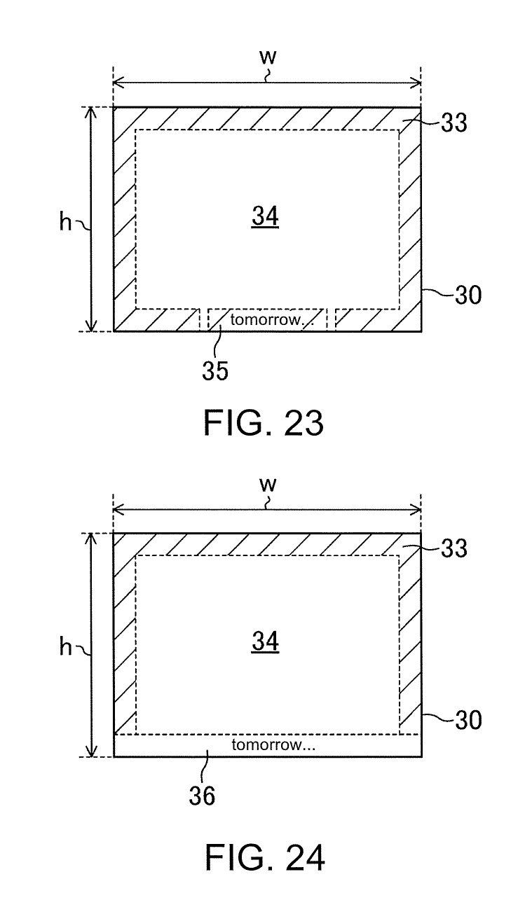

FIG. 23 is a front view showing an example of the image display region 30 on the liquid crystal panel 20 of the display apparatus 10 according to the fifth embodiment.

The image display region 30 occupies a portion of the width w and the height h in the screen 21 of the width W and the height H. Then, if character information is present in a predetermined region 35, which constitutes a portion of a side of the outer edge part 33 among four sides of the image display region 30, the controller 26 controls the luminances of the LEDs 23 located in the image display region 30, such that the central part 34 of the image display region 30 and the predetermined region 35 where the character information is present have the same luminance. As a result, the luminance of the outer edge part 33, excluding the predetermined region 35 where the character information is present, may be reduced, so as to avoid a sense of incompatibility as well as suppress the power consumption of the backlight 22.

FIG. 24 is a front view of a modified example of the example of FIG. 23. In this modified example, the entire area of a side of the outer edge part 33 among four sides of the rectangular image display region 30 is set as a predetermined region 36. If character information is present in the predetermined region 36 in the outer edge part 33 of the image display region 30, the controller 26 controls the luminances of the LEDs 23 located in the image display region 30, such that the central part 34 of the image display region 30 and the entire predetermined region 36 where the character information is present have the same luminance. As a result, the luminance of the outer edge part 33 on three sides of the image display region 30 may be reduced, so as to avoid a sense of incompatibility as well as suppress the power consumption of the backlight 22.

According to this embodiment, it is possible to achieve the optimum luminance setting of the light source part according to whether the character information is present in the predetermined regions 35 and 36 in the outer edge part 33 of the image display region 30. Therefore, the display quality of the image can be improved within limited power consumption.

Five embodiments have been described above. Nevertheless, the display is not limited to the liquid crystal panel 20. Moreover, the backlight 22 is described as a light source part separated from the display, but the display and the light source part may also be integrally formed. Further, each of the multiple light sources is not limited to the LED 23.

Additionally, in the fourth and the fifth embodiments, the detection part 25 detects the character information in the outer edge part 33 of the image display region 30 or in the predetermined regions 35 and 36 in the outer edge part, but the position of the predetermined region, i.e., the target for character detection in the image display region 30, is not limited to the outer edge part.

Further, the detection part 25 may detect the character information before characters are displayed on the liquid crystal panel 20 or may detect the character information after characters are displayed on the liquid crystal panel 20. The controller 26 may control the LEDs 23 before the liquid crystal panel 20 displays characters based on the detection result of the detection part 25 or control the LEDs 23 after the liquid crystal panel 20 displays characters based on the detection result of the detection part 25.

In addition, the five embodiments as described above may be combined as desired. For example, the luminances of the light sources located in the regions A to D in the third embodiment may be controlled based on the size of each region, as described in the fourth embodiment.

What is claimed is:

1. A display apparatus, comprising:
a display;
a plurality of light sources; and
a controller controlling the light sources,
wherein when a character information is present in a display region of the display, the controller controls a luminance of at least a region comprising the character information to be higher than a predetermined luminance.

2. The display apparatus according to claim 1, wherein the controller controls a luminance of at least a side of an outer edge part that is close to the region comprising the character information to be higher than the predetermined luminance.

3. The display apparatus according to claim 2, wherein the controller controls a luminance of all the outer edge part of the display region to be higher than the predetermined luminance.

4. The display apparatus according to claim 2, wherein the controller controls a luminance of entire one side of the outer edge part to be higher than the predetermined luminance.

5. The display apparatus according to claim 2, wherein the controller controls the luminance of the region comprising the character information and a luminance of a region other than the outer edge part to be substantially equal.

6. The display apparatus according to a claim 1, wherein the controller controls a luminance of the display region based on a size of the display region.

7. The display apparatus according to a claim 1, wherein the display comprises a plurality of display regions, and
the controller controls a luminance for each of the display regions.

8. The display apparatus according to claim 7, wherein the controller controls an average luminance of each of the display regions to be substantially equal to one another.

9. The display apparatus according to claim 1, wherein
when an image displayed in the display region comprises a first image and a second image where the first age is a content image, and the second image is an enlarged image of a specified region of the first image and is displayed outside the first image,
the controller controls a luminance of a region where the second image is displayed to be higher than a luminance of the specified region.

10. The display apparatus according to claim 1, wherein the controller controls a luminance of the light source corresponding to the region where the luminance of the display region is changed.

11. The display apparatus according to claim 1, wherein the predetermined luminance is substantially equal to a luminance of the outer edge part that does not comprise the character information of the display region.

12. The display apparatus according to claim 1, further comprising a determination part that determines a type of the image displayed in the display region,
wherein the controller controls the luminance of the light sources based on the determined type.

13. The display apparatus according to claim 12, wherein the character information is displayed in an outer edge part of the display region, and
when the determined type is a moving image, the controller controls a luminance of a region other than the outer edge part to be higher than a luminance of the outer edge part excluding the outer edge part that comprises the character information.

14. The display apparatus according to claim 12, wherein when the determined type is a still image, the controller controls all the display region to be uniformly luminance.

15. The display apparatus according to claim 1, comprising a detection part that detects a movement amount of an image in a predetermined region of the display region,
wherein the controller controls the luminance of the light sources based on the detected movement amount.

16. The display apparatus according to claim 15, wherein the controller controls a difference between a luminance of an outer edge part of the predetermined region and a luminance of a region other than the outer edge part as a first predetermined value.

17. The display apparatus according to claim 16, wherein the luminance of the outer edge part is lower than the luminance of the region other than the outer edge part.

18. The display apparatus according to claim 16, wherein the first predetermined value for a case that a movement amount of an image in the predetermined region is greater than a second predetermined value, is greater than the first predetermined value for a case a movement amount of an image in the predetermined region is less than the second predetermined value.

19. The display apparatus according to claim 16, wherein when the movement amount of the image of the predetermined region is substantially 0, the controller controls the first predetermined value to substantially 0.

20. The display apparatus according to claim 1, wherein the light sources are arranged in an elliptical shape as seen in a direction perpendicular to a main surface of the display.
